(19) United States
(12) Patent Application Publication
(10) Pub. No.: US 2023/0174220 A1
(43) Pub. Date: Jun. 8, 2023

(54) PROPELLER ASSEMBLY HAVING A PUMP UNIT

(71) Applicant: MT-Propeller Entwicklung GmbH, Atting (DE)

(72) Inventors: MARTIN ALBRECHT, Straubing (DE); Gerd Muehlbauer, Mitterfels (DE)

(21) Appl. No.: 18/073,131

(22) Filed: Dec. 1, 2022

(30) Foreign Application Priority Data
Dec. 2, 2021 (EP) 21212096.8

(51) Int. Cl. B64C 11/38; B63H 3/08

(52) U.S. Cl. CPC B64C 11/385; B63H 3/08; B63H 2003/088

(57) ABSTRACT

A hydraulically adjustable propeller assembly for an aircraft, a land vehicle or a water craft, includes an engine, a propeller unit having a propeller which comprises at least two propeller blades whose pitch is hydraulically settable, a pressure control unit which predetermines a fluid pressure for setting the pitch of the propeller blades and which is hydraulically connected to a pressure chamber of the propeller via a control line, and a pump unit which supplies a hydraulic fluid which is under a base pressure to the pressure control unit. The pump unit is a unit driven independently of the engine and the pressure control unit and includes at least one electrically operated main pump which supplies the hydraulic fluid which is under the base pressure for the pressure control unit.

### CROSS-REFERENCE TO RELATED APPLICATIONS

This application claims priority to European Patent Application No. 21212096.8 filed Dec. 2, 2021, the disclosure of which is incorporated herein by reference in its entirety and for all purposes.

### BACKGROUND

This disclosure relates to a hydraulically adjustable propeller assembly for an aircraft, a land vehicle or a watercraft.

Such a propeller assembly is known from document EP 3 466 806 B1 and is, in particular, designed for use in an airplane. It comprises a propeller comprising several propeller blades whose angle of incidence (pitch) is hydraulically settable. The propeller is driven by means of an engine which also drives a hydraulic pump which supplies a base pressure for a pressure control device by means of which a pressure is settable in a pressure chamber of the propeller. A change in the hydraulic pressure in the pressure chamber leads to a change of the pitch of the propeller blades. A piston unit is displaced in the pressure chamber via the pressure, said piston unit being coupled to the propeller blades which are rotatably mounted in the region of a propeller hub. The pitch (angle of incidence) of the propeller blades is adjustable by means of the control pressure or regulating pressure provided by the pressure control device between an angle of incidence which is associated with a feathered position and in which the propeller blades provide the least air drag during the flight operation of the respective airplane, a minimum angle of incidence which provides a propulsion to the respective airplane and a negative angle of incidence which corresponds to a reverse thrust position of the propeller blades. In the reverse thrust position, the variable-pitch propeller exerts a braking force on the respective airplane while the rotation direction of the propeller remains the same. This braking force is possibly required after touchdown of the airplane on the runway in order to shorten its braking distance. In the event of a failure of the engine or any other defect, the feathered position allows the respective airplane to safely transition to a descent and land without actual propulsion through the propellers and with minimum air drag from the propeller, or to continue the flight in the case of a multi-engine airplane. In the known propeller assembly, the problem is that the base pressure provided to the pressure control device is dependent on the engine.

### SUMMARY

The object of the disclosure at hand is to design a propeller assembly in which supplying the pressure control unit with a base pressure is ensured independently of the design of the engine.

This object is attained according to the disclosure by the hydraulically adjustable propeller assembly as described herein.

According to the disclosure, thus, a hydraulically adjustable propeller assembly for an aircraft, a land vehicle or a water craft is proposed, comprising an engine, a propeller unit having a propeller which comprises at least two propeller blades whose pitch (angle of incidence) is hydraulically settable, a pressure control unit which predetermines a fluid pressure for setting the pitch of the propeller blades and which is hydraulically connected to a pressure chamber of the propeller via a control line, and a pump unit which supplies a hydraulic fluid which is under a base pressure to the pressure control unit. The pump unit is a unit driven independently of the engine of the propeller assembly and the pressure control unit and comprises at least one electrically operated main pump which supplies the hydraulic fluid which is under the base pressure for the pressure control unit.

In the propeller assembly according to the disclosure, thus, in the form of the pump unit, a device is provided which, for operation, needs only a current supply for the main pump, which is, for example, realized as gear pump or piston circulating pump, and, thus, can be disposed on a suitable position of the respective aircraft, land vehicle or watercraft independently of the design of the engine and the pressure control unit.

In an advantageous embodiment of the propeller assembly, the pump unit may comprise a housing forming a tank for the hydraulic fluid and being spatially separated from the engine and the pressure control unit. Only a hydraulic and, if necessary, electrical connection to the pressure control unit and, if necessary, to a control device of the propeller assembly may be required.

In order to ensure that a leakage and/or a hydraulic oil deficiency and, thus, an operation of the pump unit which does not meet the requirements can be detected, the pump unit in a preferred embodiment of the propeller assembly may comprise a level sensor for the hydraulic fluid. If, for example, the level of the hydraulic fluid falls below a defined value, a signal can be sent to the pressure control unit by a control device, said signal, in particular in the case of an airplane, causing the propeller blades to move into a feathered position.

Furthermore, the pump unit advantageously may comprise an outlet opening and an inlet opening, the outlet opening and the inlet opening each being connected to the pressure control unit via a hydraulic line. One of the hydraulic lines is a supply line via which the hydraulic fluid which is under the base pressure may be provided to the pressure control unit. The other hydraulic line is a return line via which the hydraulic fluid may be led back to the pump unit, in particular into its tank, by the pressure control unit.

In order to be able to monitor the pressure with which the hydraulic fluid is supplied to the pressure control unit by the pump unit, the pump unit preferably may comprise a pressure sensor which detects a hydraulic pressure downstream of the main pump.

For redundancy reasons and to maintain a safe operation of the propeller assembly, the pump unit preferably may comprise an electrically operated standby pump which is configured to supply the hydraulic fluid with the base pressure for the pressure control unit when the hydraulic pressure provided by the main pump falls below a minimum pressure. The minimum pressure may be 5 bar, for example. If the pressure is below a minimum pressure, the operation of the pump unit may be preferably automatically switched to the standby pump, for example via a control unit of the propeller assembly. This makes it possible to continue to operate the system and/or the propeller assembly safely, even in the event of a failure of the main pump. The standby pump may be, for example, a gear pump or a piston circulating pump. The standby pump can be identical in construction to the main pump, but it can also differ from it (for example, it can have a lower output).

In order to be also able to measure the hydraulic pressure generated by the standby pump, the pump unit of the propeller assembly preferably may comprise a standby pressure sensor additionally to the pressure sensor.

In order to provide an integrated system, the propeller assembly preferably may comprise an electronic control device which is connected to the pump unit via corresponding signal lines. The electronic control device can be realized by a so-called FADEC (full authority digital engine control) which, in particular, allows a fully digital control of the propeller assembly.

In a preferred embodiment of the propeller assembly, the pressure control unit, which represents a so-called beta valve, may be designed in such a manner that it comprises a valve spool whose position determines the fluid pressure for setting the angle of incidence of the propeller blades. Displacing the valve spool causes a pressure change in the control line connected to the pressure chamber of the propeller, such that the piston to which the propeller blades are connected and on which the pressure prevailing in the pressure chamber acts is moved, which, in turn, leads to an adjustment of the pitch (angle of incidence) of the propeller blades.

In a preferred embodiment of the propeller assembly, the control line may comprise a control tube on which the valve spool is mounted and which is connected to the pressure chamber of the propeller. The control tube, which realizes a so-called beta tube and which is axially movable with respect to a housing of the pressure control unit, may run, in particular, from the pressure control unit to the propeller unit, a hub of the propeller unit preferably being penetrated by the control tube.

In order to displace the valve spool, the pressure control unit may comprise a control rod which is connected to the valve spool and is capable of being mechanically, hydraulically, electrically and/or manually actuated.

The pressure control unit may furthermore preferably designed in such a manner that the valve spool is delimited at its circumference by an annular space which is pressurized with the base pressure by the pump unit and is connected to the control line via at least one transverse bore of the valve spool. The transverse bore may interact with at least one transverse bore of the control line in order to set the control pressure and/or the fluid pressure in the control line. As a function of an overlap of the transverse bore of the valve spool with the transverse bore of the control line, the control pressure (the fluid pressure) in the control line may change.

In order to allow the safe landing of an airplane in which the propeller assembly according to the disclosure is used (for example, in the event of a system failure, such as a failure of the pump unit), the pressure control unit preferably may comprise a feather valve which is configured to reduce the fluid pressure in the control line in such a manner that the propeller blades move into a feathered position. The moving operation into the feathered position may be carried out, in particular, by return springs which engage on the piston of the propeller unit and by centrifugal weights which act directly on the propeller blades and which exert an actuating force on the propeller blades when the propeller rotates, said actuating force acting in the direction of the feathered position of said propeller blades.

Further advantages and advantageous embodiments of the subject matter of the disclosure can be obtained from the description, the drawings and the claims. In the description, reference is made to the accompanying drawings that form a part hereof, and in which there is shown by way of illustration one or more exemplary versions. These versions do not necessarily represent the full scope of the disclosure.

### BRIEF DESCRIPTION OF THE DRAWINGS

An exemplary embodiment of a hydraulically adjustable propeller assembly is illustrated in a schematically simplified manner in the drawing and is explained in more detail in the description. In the figures:

FIG. 1 shows an overview illustration of a propeller assembly of an airplane;

FIG. 2 shows a longitudinal section through a propeller unit of the propeller assembly;

FIG. 3 shows a longitudinal section through a pressure control unit of the propeller assembly;

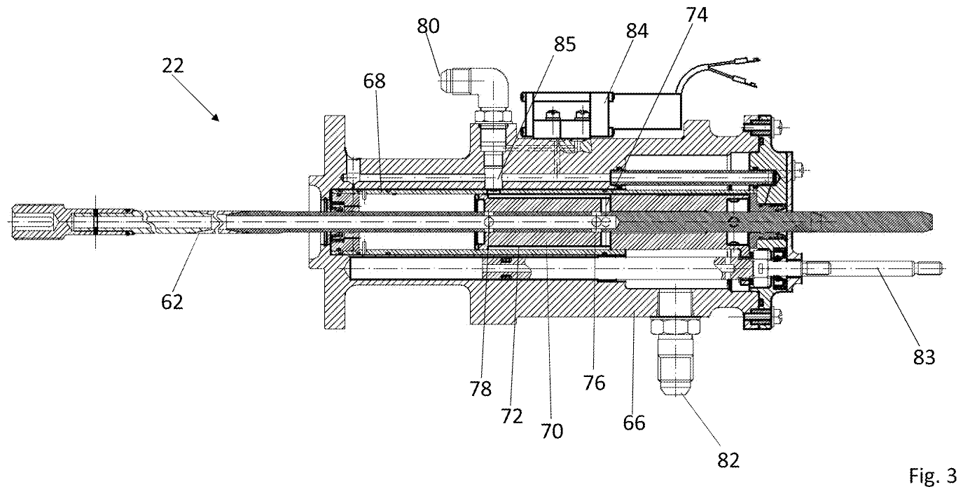

FIG. 4 shows a pump unit of the propeller assembly; and

FIG. 5 shows a hydraulic connection scheme of the propeller assembly.

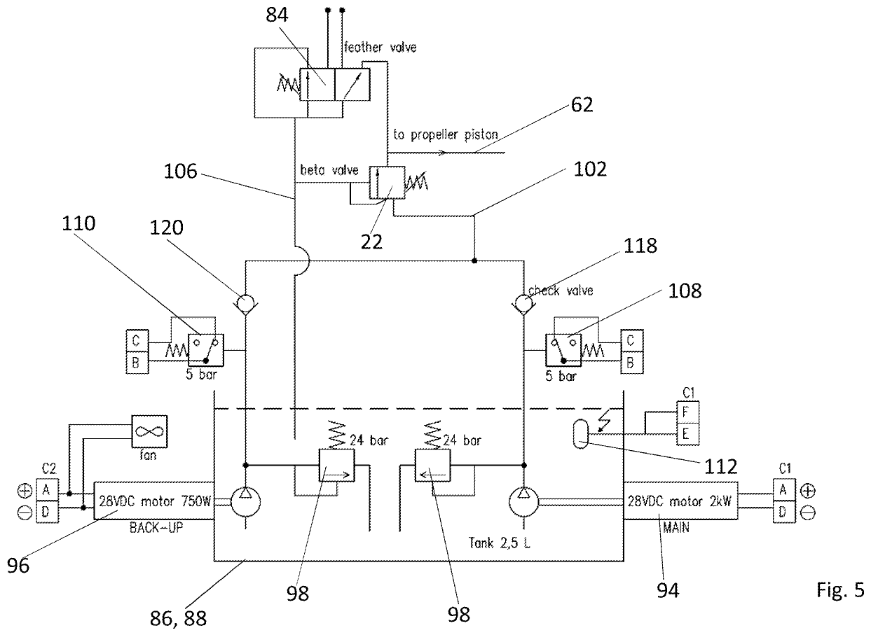

### DETAILED DESCRIPTION

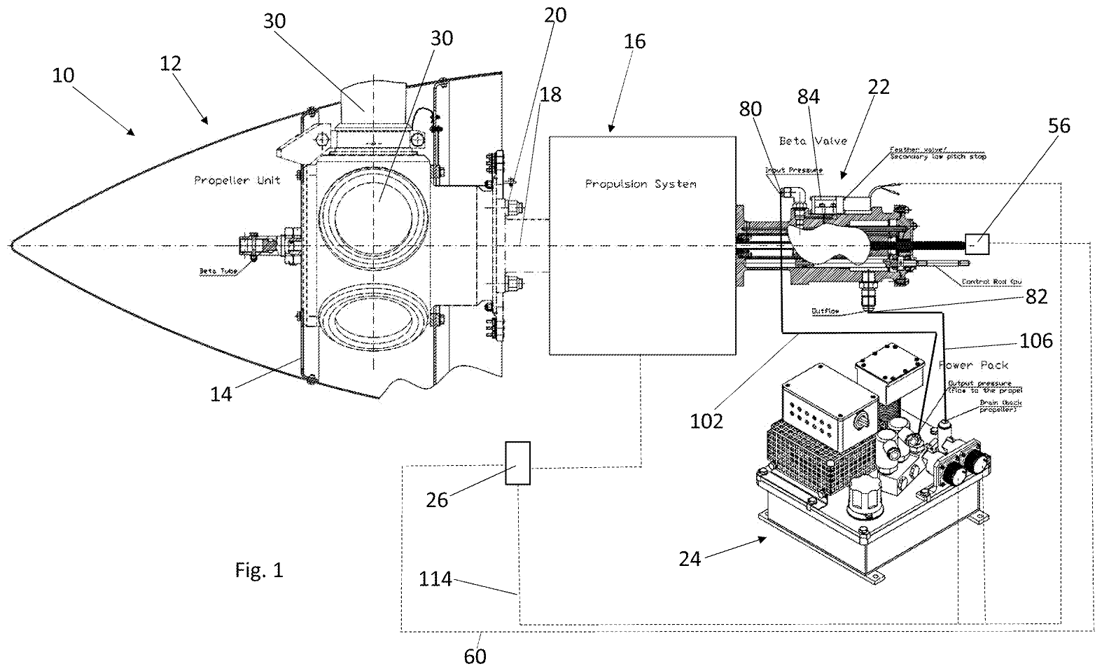

In FIG. 1, a propeller assembly 10 for an airplane, i.e. an aircraft, is illustrated in a highly schematized manner. Propeller assembly 10 comprises a propeller unit 12, which has a propeller 14, and an engine 16 which can comprise a combustion engine or also an electric motor and can rotatably drive propeller 14 via a drive shaft 18. Propeller unit 12 is mounted in an airplane-fixed manner via a mounting flange 20.

Moreover, propeller assembly 10 comprises a pressure control unit 22 which serves to hydraulically adjust propeller 14. Furthermore, propeller assembly 10 has a pump unit 24 which supplies a hydraulic fluid with a base pressure for pressure control unit 22. The propeller assembly furthermore comprises an electronic control device 26 which can be realized by a so-called FADEC (full authority digital engine control).

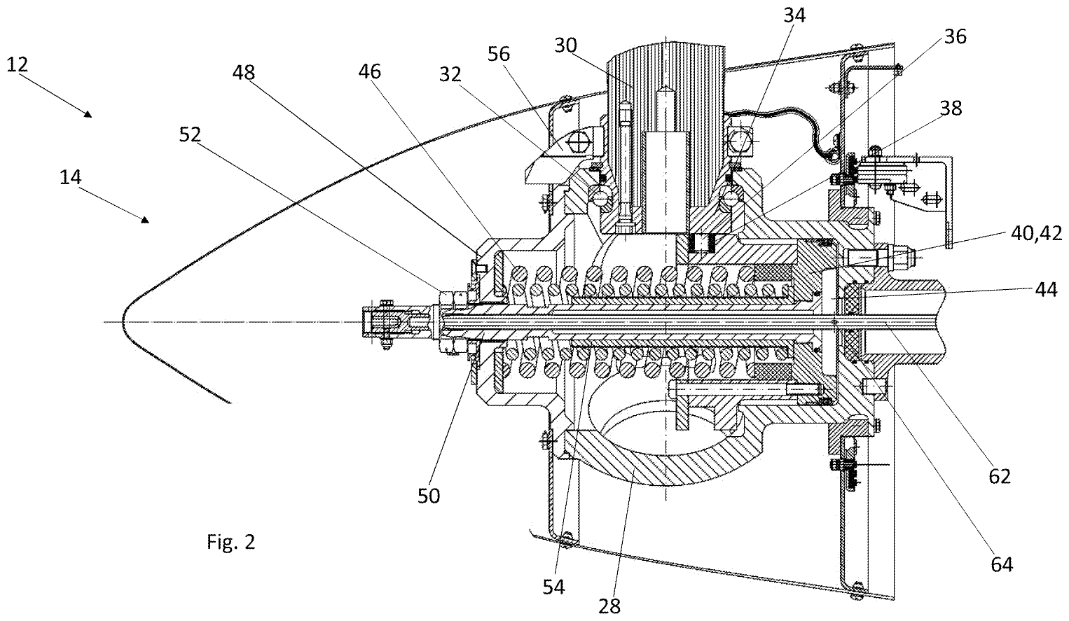

Propeller 14, which is illustrated in an enlarged manner in FIG. 2, comprises a propeller hub 28 on which several propeller blades 30 are rotatably mounted via respective blade bearings 32. Each propeller blade 30 has a blade root 34 on whose end side which faces radially inward is disposed an adjusting pin 36 which engages into a corresponding recess of a sliding block 38 which is connected to a piston unit 40. Piston unit 40 comprises an annular piston 42 which is adjacent to a pressure chamber 44 in which a regulating pressure for determining a pitch (angle of incidence) of propeller blades 30 prevails.

Propeller blades 30 can be adjusted with respect to their pitch between a feathered position and a maximum reverse thrust position. This is carried out by changing the hydraulic pressure or regulating pressure prevailing in pressure chamber 44.

Piston 42 is preloaded in the direction of the position illustrated in FIG. 2, in which propeller blades 30 take their feathered position, by a return spring arrangement 46 which is supported on a front plate 48 of propeller hub 28. Return spring arrangement 46 which is realized by coil springs surrounds a central guide tube 50 which penetrates piston unit 40. On the end side, guide tube 50 is provided with stop nuts 52 which, in the feathered position, abut against the outside of front plate 48 of propeller hub 28. Guide tube 50 is surrounded by a tube-like bushing which is pressed against piston 42 by one of the springs of return spring arrangement 46 and forms with its end side which faces away from piston 42 a stop which defines a minimum blade angle of propeller blades 30 in the reverse thrust position.

During flight operation or when propeller 14 is rotating, furthermore, an adjusting moment is exerted on propeller blades 30 by centrifugal weights 56, said adjusting moment acting in the direction of the feathered position.

In order to measure the pitch or blade angle of propeller blades 30, propeller 14 can have a blade angle measuring device 56 which, for example, comprises a position sensor disposed in the region of pressure control unit 22, wherein said position sensor can be realized as a so-called LVDT (linear variable differential transformer) which is connected to control device 26 via a signal line 60.

In order to be able to change the hydraulic pressure (fluid pressure) in pressure chamber 44 of propeller 14, propeller assembly 10 comprises a control tube 62 realized as a so-called beta tube whose interior is connected to pressure chamber 44 via at least one transverse bore 64 and which penetrates propeller hub 28 in guide tube 50 completely in the axial direction. Control tube 62 which moves together with piston 42 penetrates with its region facing away from propeller 14 pressure control unit 22 or is part of the same. The position sensor of blade angle measuring device 56 detects a movement of control tube 62.

Pressure control unit 22 which realizes a so-called beta valve comprises a valve housing 66 into which a valve bushing 68 is inserted whose axis coincides with the axis of control tube 62 which penetrates the valve housing. In valve bushing 68, a valve spool 70 is displaceably guided. Valve spool 70 delimits at its circumference an annular space 72 which is delimited radially outside by valve bushing 68. Annular space 72 is connected to control tube 62 via transverse bores 74. Control tube 62 has transvers bores 76 and 78 in the region of valve bushing 68.

Furthermore, pressure control unit 22 has an inlet 80 and an outlet 82. Via outlet 82, hydraulic oil is discharged from pressure control unit 22 and pressure chamber 44 of propeller unit 12. Via inlet 80, a hydraulic fluid with a base pressure is supplied, said hydraulic fluid being guided to annular space 72 between valve bushing 68 and valve spool 70 via a channel 85.

On the basis of the base pressure acting in annular space 72, a control pressure and/or fluid pressure is set in control tube 62 and, thus, in pressure chamber 44 of propeller 14 as a function of a degree of overlap between transverse bores 74 and transverse bores 76. A movement of valve spool 70 is carried out by a control rod 83 which is capable of being manually, hydraulically, electrically and/or mechanically actuated and is connected to valve spool 70.

Furthermore, pressure control unit 22 comprises a feather valve 84 by which the pressure prevailing in annular space 72 can be lowered, if necessary, such that the control pressure and, thus, the pressure prevailing in pressure chamber 44 of propeller 14 is reduced and propeller blades 30 return automatically to their feathered position due to the action of centrifugal weights 56 and return spring arrangement 46.

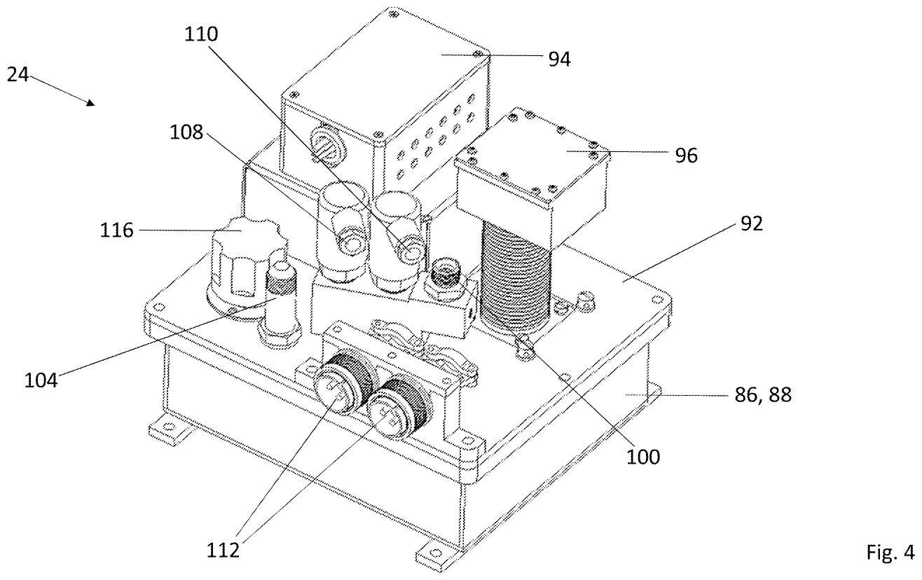

The hydraulic oil with the base pressure is supplied by pump unit 24 illustrated on its own in FIG. 4. Pump unit 24 comprises a housing 86 having an at least essentially rectangular outline and realizing a tank 88 for hydraulic oil. Tank 88 represents an oil pan which is closed by a cover 92. Via a closure 116 at cover 92 of pump unit 24, hydraulic oil can be filled into tank 88. Said tank 88 has a capacity of approximately 2.5 L. Pump unit 24 is provided with a level sensor 122 which sends a control signal to control device 26 when hydraulic oil in tank 88 falls below a minimum level.

Furthermore, pump unit 24 has an electric main pump 94 which is, for example, realized as a gear pump and an electric standby pump 96 which is, for example, also realized as a gear pump. Main pump 94 operates with an electric voltage of, for example, 28 volts and produces an output of, for example, 2 kW. Standby pump 96 operates with an electric voltage of, for example, 28 volts and produces an output of, for example, 750 W. The maximum pump pressure which main pump 94 and standby pump 96 can provide is set by respective pressure limiters 98 and is, for example, 24 bar.

Pump unit 24 has an outlet opening 100 which is connected to inlet 80 of pressure control unit 22 via a hydraulic line 102. A return opening 104 of pump unit 24 is connected to outlet 82 of pressure control unit 22 via a hydraulic line 106.

Upstream of outlet opening 100, check valves 118 and 120 are assigned to the two pumps 94 and 96, respectively, said check valves 118 and 120 preventing hydraulic oil supplied by one of the two pumps 94 and 96 of pressure control unit 22 from flowing into the direction of the other one of the two pumps 94 and 96.

Furthermore, pump unit 24 comprises a main pressure sensor 108 for the hydraulic pressure provided by main pump 94 and a standby pressure sensor 110 for the hydraulic pressure provided by the standby pump. Pressure sensors 108 and 110 are designed in such a manner that they send a signal, in particular, to control device 26 as soon as the pressure provided by respective pump 94 or 96 is below 5 bar.

Moreover, pump unit 24 comprises electrical connection elements 112 via which pump unit 24 can be connected to a current source and to electronic control device 26 via signal lines 114. Signal lines 114 also run to feather valve 84 and to engine 16.

Propeller assembly 10 described above operates in the manner described below.

Propeller 14 is driven by engine 16 via drive shaft 18 with the predetermined rotational speed.

In their normal position, propeller blades 30 take their respective feathered position in which the hydraulic pressure in pressure chamber 44 of propeller 14 is not sufficient to displace piston 42 against the restoring force of restoring spring arrangement 46 and centrifugal weights 56.

By use of the pump unit in which main pump 94 is driven during standard operation, a base pressure is provided to pressure control unit 22 via hydraulic line 102. By moving valve spool 70 by means of control rod 83, based on the base pressure prevailing in annular space 72, the pressure in control tube/beta tube 62 and, thus, the pressure in pressure chamber 44 can be increased, as a result of which piston 42 is displaced against the restoring forces and the pitch (angles of incidence) of propeller blades 30 are changed. The base pressure provided by main pump 94 is, for example, maximally 24 bar.

In the event of a failure or defect of main pump 94, the pump pressure can fall below 5 bar. This is detected by main pressure sensor 108, which, as a result, transmits a control signal to control device 26, which then activates the operation of standby pump 96, which, as a result, provides a sufficient base pressure for pressure control unit 22 via hydraulic lines 102.

In the event of a malfunction, control device 26 can send a control signal to feather valve 84 which then switches the system essentially in a pressure-less manner such that the hydraulic pressure prevailing in control rod 62 and pressure chamber 44 drops, as a result of which propeller blades 30 automatically move into their feathered position due to the restoring forces of return spring arrangement 46 and centrifugal weights 56.

This discussion is presented to enable a person skilled in the art to make and use embodiments of the disclosure. Various modifications to the illustrated examples will be readily apparent to those skilled in the art, and the generic principles herein can be applied to other examples and applications without departing from the principles disclosed herein. Thus, embodiments of the disclosure are not intended to be limited to embodiments shown, but are to be accorded the widest scope consistent with the principles and features disclosed herein and the claims below. The following detailed description is to be read with reference to the figures, in which like elements in different figures have like reference numerals. The figures, which are not necessarily to scale, depict selected examples and are not intended to limit the scope of the disclosure. Skilled artisans will recognize the examples provided herein have many useful alternatives and fall within the scope of the disclosure.

Various features and advantages of the disclosure are set forth in the following claims.

### REFERENCE SIGNS

10 propeller assembly
12 propeller unit
14 propeller
16 engine
18 drive shaft
20 mounting flange
22 pressure control unit
24 pump unit
26 control device
28 propeller hub
30 propeller blade
32 blade bearing
34 blade root
36 adjusting pin
38 sliding block
40 piston unit
42 piston
44 pressure chamber
46 return spring arrangement
48 front plate
50 guide tube
52 stop nut
54 bushing (stop for minimum blade angle)
56 blade angle measuring device
58 position sensor
60 signal line
62 control tube
64 transverse bore
66 valve housing
68 valve bushing
70 valve spool
72 annular space
74 transverse bore
76 transverse bore
78 transverse bore
80 inlet
82 outlet
83 control rod
84 feather valve
85 channel
86 housing
88 tank
92 cover
94 main pump
96 standby pump
98 pressure limiter
100 outlet opening
102 hydraulic line
104 return opening
106 hydraulic line
108 main pressure sensor
110 standby pressure sensor
112 electrical connection elements
114 signal line
116 closure
118 check valve
120 check valve
122 level sensor

1. A hydraulically adjustable propeller assembly for an aircraft, a land vehicle or a water craft, comprising an engine, a propeller unit having a propeller which comprises at least two propeller blades whose pitch is hydraulically settable, a pressure control unit which predetermines a fluid pressure for setting the pitch of the propeller blades and which is hydraulically connected to a pressure chamber of the propeller via a control line, and a pump unit which supplies a hydraulic fluid which is under a base pressure to the pressure control unit, wherein the pump unit is a unit driven independently of the engine and the pressure control unit and comprises at least one electrically operated main pump which supplies the hydraulic fluid which is under the base pressure for the pressure control unit.

2. The hydraulically adjustable propeller assembly according to claim 1, wherein the pump unit comprises a housing forming a tank for the hydraulic fluid and being spatially separated from the engine and the pressure control unit.

3. The hydraulically adjustable propeller assembly according to claim 1, wherein the pump unit comprises a level sensor for the hydraulic fluid.

4. The hydraulically adjustable propeller assembly according to claim 1, wherein the pump unit comprises an outlet opening and a return opening for hydraulic fluid and wherein the outlet opening and the return opening each are connected to the pressure control unit via a hydraulic line.

5. The hydraulically adjustable propeller assembly according to claim 1, wherein the pump unit comprises a pressure sensor which detects a hydraulic pressure downstream of the main pump.

6. The hydraulically adjustable propeller assembly according to claim 1, wherein the pump unit comprises an electrically operated standby pump which is configured to supply the hydraulic fluid with the base pressure when the hydraulic pressure provided by the main pump is below a minimum pressure.

7. The hydraulically adjustable propeller assembly according to claim 6, wherein the pump unit comprises standby pressure sensor which detects a hydraulic pressure provided by the standby pump.

8. The hydraulically adjustable propeller assembly according to claim 1, further comprising an electronic control device to which the pump unit is connected.

9. The hydraulically adjustable propeller assembly according to claim 1, wherein the pressure control unit comprises a valve spool whose position with respect to a valve housing determines the fluid pressure for setting the pitch of the propeller blades.

10. The hydraulically adjustable propeller assembly according to claim 9, wherein the control line comprises a control tube on which the valve spool is movable and which is connected to the pressure chamber of the propeller.

11. The hydraulically adjustable propeller assembly according to claim 9, wherein the valve spool is connected to a control rod which is capable of being mechanically, hydraulically, electrically and/or manually actuated.

12. The hydraulically adjustable propeller assembly according to claim 9, wherein the valve spool is delimited at its circumference by an annular space which is pressurized with the base pressure and is connected to the control line via at least one transverse bore.

13. The hydraulically adjustable propeller assembly according to claim 9, wherein the pressure control unit comprises a feather valve which is configured to reduce the fluid pressure in the control line in such a manner that the propeller blades move into a feathered position.
